(19) United States
(12) Patent Application Publication
(10) Pub. No.: US 2025/0085952 A1
(43) Pub. Date: Mar. 13, 2025

(54) SYSTEMS AND METHODS FOR FACILITATING PROVISIONING OF SOFTWARE SOLUTIONS

(71) Applicant: Linvest21, Inc., Tuxedo Park, NY (US)

(72) Inventors: David Dong Lin, Tuxedo Park, NY (US); Yangdi Lu, Toronto (CA); Yunfan Ma, Tuxedo Park, NY (US)

(21) Appl. No.: 18/828,876

(22) Filed: Sep. 9, 2024

Related U.S. Application Data
(60) Provisional application No. 63/581,459, filed on Sep. 8, 2023.

(51) Int. Cl. G06F 8/61; G06F 8/35; G06F 8/36

(52) U.S. Cl. CPC G06F 8/61; G06F 8/35; G06F 8/36

(57) ABSTRACT

The present disclosure provides a method for facilitating provisioning of software solutions. Further, the method includes obtaining input data. Further, the input data includes natural language input data. Further, the method includes analyzing the input data using each of a prompt model and a large language model. Further, the prompt model is coupled with the large language model. Further, the large language model is trained on a training data. Further, the prompt model interprets input data for generating requirements of the users. Further, the large language model processes the requirements for designing the software solutions. Further, the method includes generating software solution information for the provisioning of software solutions based on the analyzing of the input data. Further, the method includes transmitting the software solution information to devices. Further, the method includes storing the software solution information and each of the prompt model and the large language model.

### FIELD OF DISCLOSURE

Generally, the present disclosure relates to the field of data processing. More specifically, the present disclosure relates to methods and systems for facilitating provisioning of software solutions.

### BACKGROUND

In the realm of software development, the journey from concept to completion is traditionally labor-intensive, demanding significant time and resources. As software systems evolve in complexity, challenges related to scalability, adaptability to diverse industry-specific demands, and geographical requirements become pronounced.

Artificial Intelligence (AI) introduced potential solutions, with tools offering code snippets and assisting in modular completions. However, coders often overlook the nuances of broader software architectures and enterprise-level systems.

Vendor software systems, post-sale, pose challenges in integration, customization, and upgrades within client ecosystems. These challenges often lead to system incompatibilities, expensive customizations, and the complexities of updating systems without disruptions. Despite the progress of the open-source Large Language Model (LLM), the coders often miss the mark on enterprise needs, compromising on consistency.

In today's fast-paced technological landscape, the software development industry grapples with labor-Intensity. Further, traditional methods are slow and expensive. By leveraging AI and particularly Large Language Models, the platform drastically reduces labor intensity, speeding up the development process. Further, the software development industry sees inconsistencies across Environments. Further, different behaviors across environments lead to unpredictable issues. With technologies like Docker and Kubernetes, the platform ensures consistency, making the concern obsolete. Further, the software development industry sees scalability concerns. Further, traditional methods struggle with seamless scalability. The platform's approach ensures effortless scalability, irrespective of user base growth. Further, the software development industry sees integration woes. Further, bespoke solutions for integration increase development time and errors. The platform's unique approach to integration, customization, and upgrades offers adaptability, making it future-proof. Further, the software development industry grapples with rapid technological Evolution: The challenge of keeping up with the ever-evolving tech stack is constant. The platform is aligned with the rapid pace of technological evolution, ensuring software remains up-to-date and secure.

By addressing these prevalent issues, the platform revolutionizes the software development process, presenting a timely evolution attuned to the demands of the modern digital landscape.

Existing techniques for software development are deficient with regard to several aspects. In existing technologies, the software development industry grapples with several factors concerning broader software architectures and enterprises. As a result, different technologies are needed for developing robust software applications that cater to the needs of large enterprises. In existing technologies, developing robust software applications requires considerable human effort. As a result, different technologies are needed to minimize the human effort for a less labor-intensive and faster development.

In existing technologies, software development methods are slow and uneconomic. Moreover, different behaviors across different environments cause additional unpredictable issues. As a result, different technologies are needed for faster and more efficient development methods for software applications to ensure consistency throughout different environments. Existing technologies pose challenges in data manipulation within client ecosystems. As a result, different technologies are needed to cater to the client's needs overlooked by the vendor software systems. In existing technologies, scalability is hindered when it comes to large enterprises. As a result, different technologies are needed to reduce scalability concerns in case of an increase in user base growth.

Furthermore, existing technologies see an increase in several errors while integrating software applications. As a result, different technologies are needed to reduce errors thereby reducing development time. Moreover, existing technologies lag in keeping up with the evolving tech stack to align with the industry's needs. As a result, different technologies are needed for future adaptability and revolutionizing the software development process.

Therefore, there is a need for improved methods and systems for facilitating provisioning of software solutions that may overcome one or more of the above-mentioned problems and/or limitations.

### SUMMARY OF DISCLOSURE

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present disclosure provides a method for facilitating provisioning of software solutions. Further, the method may include obtaining, using a processing device, one or more input data associated with one or more users. Further, the one or more input data includes one or more natural language input data associated with one or more natural languages. Further, the method may include analyzing, using the processing device, the one or more input data using each of a prompt model and a large language model. Further, the prompt model may be coupled with the large language model. Further, the large language model may be trained on a training data. Further, the prompt model interprets input data for generating requirements of the one or more users. Further, the large language model processes the requirements for designing the software solutions for the one or more users. Further, the method may include generating, using the processing device, one or more software solution information for the provisioning of one or more software solutions based on the analyzing of the one or more input data. Further, the method may include transmitting, using a communication device, the one or more software solution information to one or more devices. Further, the method may include storing, using a storage device, the one or more software solution information and each of the prompt model and the large language model.

The present disclosure provides a system for facilitating provisioning of software solutions. Further, the system may include a processing device. Further, the processing device may be configured for obtaining one or more input data associated with one or more users. Further, the one or more input data includes one or more natural language input data associated with one or more natural languages. Further, the processing device may be configured for analyzing the one or more input data using each of a prompt model and a large language model. Further, the prompt model may be coupled with the large language model. Further, the large language model may be trained on a training data. Further, the prompt model interprets input data for generating requirements of the one or more users. Further, the large language model processes the requirements for designing the software solutions for the one or more users. Further, the processing device may be configured for generating one or more software solution information for the provisioning of one or more software solutions based on the analyzing of the one or more input data. Further, the system may include a communication device configured for transmitting the one or more software solution information to one or more devices. Further, the system may include a storage device configured for storing the one or more software solution information and each of the prompt model and the large language model.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 for facilitating provisioning of software solutions, in accordance with some embodiments.

FIG. 4 illustrates a flowchart of a method 400 for facilitating provisioning of software solutions including generating, using the processing device 902, the large language model, in accordance with some embodiments.

FIG. 5 illustrates a flowchart of a method 500 for facilitating provisioning of software solutions including generating, using the processing device 902, the training data for the large language model, in accordance with some embodiments.

FIG. 6 illustrates a flowchart of a method 600 for facilitating provisioning of software solutions including training, using the processing device 902, the large language model, in accordance with some embodiments.

FIG. 7 illustrates a flowchart of a method 700 for facilitating provisioning of software solutions including generating, using the processing device 902, the at least one input data, in accordance with some embodiments.

FIG. 8 illustrates a flowchart of a method 800 for facilitating provisioning of software solutions including generating, using the processing device 902, at least one improvement information for improving the functioning of the at least one software solution, in accordance with some embodiments.

FIG. 9 illustrates a block diagram of a system 900 for facilitating provisioning of software solutions, in accordance with some embodiments.

FIG. 10 illustrates a block diagram of the system 900 comprising the one or more input devices 1002 for facilitating the provisioning of the software solutions, in accordance with some embodiments.

FIG. 11 illustrates a block diagram of the system 900, in accordance with some embodiments.

FIG. 12 is a flowchart of a method 1200 for facilitating software development using artificial intelligence models, in accordance with some embodiments.

FIG. 13 is a flowchart of a method 1300 for facilitating software development using artificial intelligence models, in accordance with some embodiments.

FIG. 14 is a block diagram of a system 1400 for facilitating software development using artificial intelligence models, in accordance with some embodiments.

FIG. 15 is a block diagram of a system 1500 for facilitating software development using artificial intelligence models, in accordance with some embodiments.

FIG. 16 is a block diagram of a system 1600 for facilitating software development using artificial intelligence models, in accordance with some embodiments.

FIG. 17 is a block diagram of a system 1700 for facilitating software development using artificial intelligence models, in accordance with some embodiments.

FIG. 18 is a block diagram of the system 1700 for facilitating software development using artificial intelligence models, in accordance with some embodiments.

FIG. 19 is a block diagram of a system 1900 for facilitating software development using artificial intelligence models, in accordance with some embodiments.

FIG. 20 is a block diagram of the system 1900 for facilitating the software development using the artificial intelligence models, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices 1102 operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performances of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices.

Another objective may be to restrict a location of one or more of an input data, an output data, and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes methods and systems for facilitating software development using artificial intelligence models.

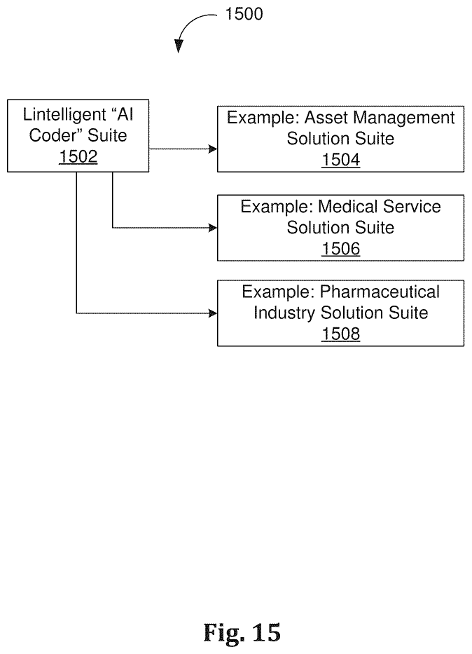

Further, the disclosed system may be associated with an artificial intelligence (AI) based software development platform that produces (for a broad spectrum of computational languages, such as React JS, Java, Python, Rust, etc.) enterprise software platforms of end-to-end capabilities from user interface to server-side logics, to data storage and usage, serving global locations (Americas, Europe, Asia, etc.) concurrently with scale, and no or minimum human coding effort, as shown in FIG. 15.

Proprietary Prompt Models comprise custom-designed language models tailored to interpret and act upon user prompts specific to the AI-based software development platform's functionality. Further, Human-Language-Like Specification Process comprises a method wherein software specifications are provided in a format resembling natural human language, facilitating easier communication of software design requirements. Further, Docker refers to a platform used for developing, shipping, and running applications inside containers. In accordance with the present disclosure, Docker ensures application consistency across multiple environments by encapsulating the applications in containers. Further, the encapsulation allows for rapid deployment and scalability, essential for modern software solutions. Further, Kubernetes refers to an open-source container orchestration platform designed to automate deploying, scaling, and operating application containers. In the platform, Kubernetes plays a pivotal role in managing and scaling services seamlessly, ensuring high availability and fault tolerance. Further, the AWS (Amazon Web Services) comprises a subsidiary of Amazon providing on-demand cloud computing platforms and APIs. AWS's robust infrastructure and a vast array of services make the AWS a preferred choice for the platform. AWS offers scalability, reliability, and global reach, which are critical for enterprise-grade applications. Furthermore, AWS's integration capabilities mean that the platform can leverage cutting-edge cloud technologies effortlessly. Further, Domain-based Embedding to LLMs comprises a process that integrates domain-specific knowledge into Large Language Models (LLMs) by embedding relevant information within the model's architecture. The embedding allows the LLM to have an inherent understanding of the domain, making its responses and interactions more contextually relevant and precise. Further, Domain-based Fine-Tuning to LLMs comprises a subsequent step after embedding, wherein the pre-trained LLM is further trained on domain-specific data. The fine-tuning ensures that the LLM not only possesses inherent domain knowledge but can also generate outputs that align closely with domain-specific nuances and requirements.

Further, “prompt models” refer to flexible, semantics-rich, and interpretation-stable (by the LLMs) prompt language constructs to enable a “human-language-like specification process” (the Specification Process). “The LLM models” consist of proprietorially trained and fine-tuned LLMs with both domain data and computational logics in desired coding languages (e.g., Java or Python). The “prompt models” may be aware and paired with the “LLM models” to produce domain-aware software platforms with rich, stable, quality, and scalable solutions with no or minimum human involvement. Further, the LLM models may act as a “brain” that retains knowledge and becomes smarter (of the domain) by producing systems and integrating with clients. The prompt models act as the language to tease out the “brain” in producing final systems.

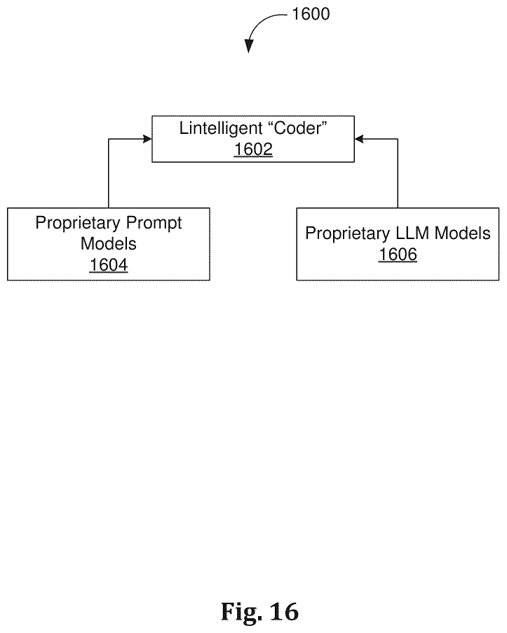

Further, as shown in FIG. 16, the training and fine-tuning of the LLM models may include the training and fine-tuning of “data” that refers to the process of building out extensive training data on “domain data” for relevant topical areas of a specific domain (for instance—the financial service industry) to train and fine-tuning proprietary LLMs. For illustration purposes, the topical areas of a domain such as investment management could refer to security master, investment book of record, market data, reference data, etc.

Further, the training and fine-tuning of “computational logics” in coding format-refer to sub-processes including building out extensive training data in “computational logic” in the forms of desired computational language (e.g., Java or Python) with desired tech stack (e.g., React, Spring Boot, Kafka, Ignite and preferred RDBMS) and scaling framework (e.g., Docker and/or any public clouds) for the target solution/system.

Further, the system intentionally produces software solutions that may be agnostic to scaling infrastructure. Further, the system may scale with best-of-the-breed or most-fitting scaling technology including container clustering, or a form of public cloud to avoid cloud-lock-in and enable pricing flexibility with vendors.

Further, powerful scaling infrastructure, such as public clouds (including AWS) integrates natively with open-source container technology, such as Docker, as well as container orchestration solutions like Kubernetes. As a result, by producing software using Docker and Kubernetes natively, the platform effectively enables cloud independence (of the target system) while retaining key features of clouds with minor re-configuration. On the contrary, if the platform produces a system/solution tied to a particular cloud (such as AWS), the platform will pose a challenge to integrate with other clouds when the clouds rise to the top or have desirable features to integrate with. Further, establishing unique “prompt” models/languages to work with the “LLM models”, so that the specifications can be written in the prompt models/language with stable output from the LLMs. The prompt models/languages demonstrate the characteristics including rich in semantic constructs and meaning, and describe various circumstances, needs, and capabilities. Further, the prompt models may be domain-knowledgeable on concepts, data format, computational logics, and workflows. Further, the LLMs perform a stable interpretation, so the corresponding outputs may be consistent from inquiry to inquiry.

Further, on financial concept training, the platform employs the most advanced LLM, combined with a (human) domain expert to produce appropriately formatted training data. Domain data training includes employing industry-standard data sources, for instance-using the MSCI Barra Risk model for Risk Data and dimensions, using the GICs Sector model for sector data and dimensions, etc. On computational logic (including workflow) training includes establishing proprietary workflow and computing model in the form of working code (e.g., Python, Java, etc.), with desired design patterns (e.g., Model View Controller) and technical stacks (e.g., Docker, Kafka, Ignite, etc.). The forms correspond to the “training data” in the area.

Further, the platform establishes “Training Data Reviewer”. Further, the platform employs the most advanced public LLM, combined with a (human) domain expert to review at each iteration of the above steps (on both content and format). Further, the system supports human-language-like specifications that may be semantically rich, and well-tested with the LLMs, producing stable outcomes. More specifically, the specifications (in the form of the prompt models/languages) produce an enterprise and complete working system with built-in quality, robustness, scalability, and no or minimum human coding effort, as follows:
generate entity object Security.java mapping to postgres db table security_master.security based on schema “TABLE security_master.securities (security_id uuid PRIMARY KEY DEFAULT id_generate_v4 ( ) security_type varchar (255), issuer varchar (255), description varchar (255), valid_from timestamp (7), valid_to timestamp (7), UNIQUE (security_type, issuer, description)”, using “SELECT CAST (security_id as varchar), security_type, issuer description, valid from, valid_to FROM security_master.securities” with security_id mapping to String, provide package declartion, import java.sql.TimeStamp, javax.persistence.*, org.hibernate.annotations.Type, constructor, getters and setters. print “---”.

```
Action: NEW
File_Type: java
Directory: /home/lindong/project/solution-linvest21/linvest21-v1/my-
springboot-app/src/main/java/com/linvest21/investment/model
File_Name: Security.java
File_Content:
package com.linvest21.investment.model;
import javax.persistence.*;
import java.sql.Timestamp;
@Entity
@Table(name = “securities”, schema = “security_master”)
public class Security {
  @Id
  @Column(name = “security_id”)
  private String securityId;
  @Column(name = “security_type”)
  private String securityType;
  @Column(name = “issuer”)
  private String issuer;
  @Column(name = “description”)
  private String description;
  @Column(name = “valid_to”)
  private String validTo;
  public Security( ) { }
  // getters and setters
}
```

Further, the system features unique multi-modality in the specification process, by supporting both written form and voice-input-based specifications, and iterations

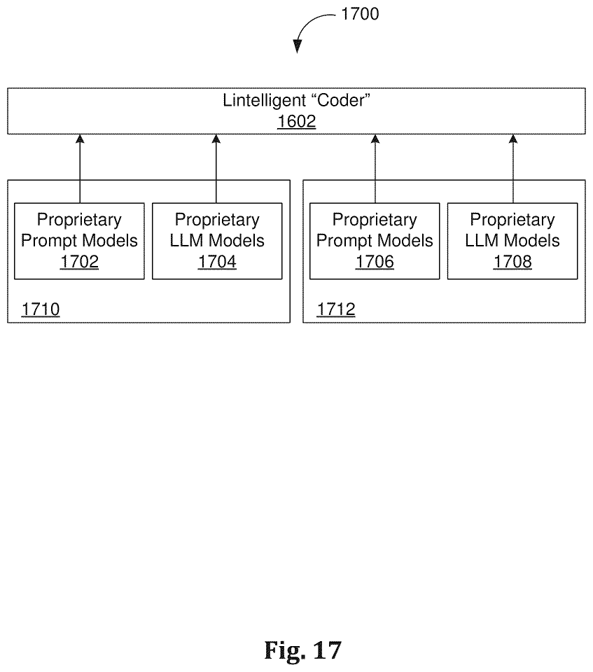

Further, the system operates in 2 modes including a “single-coder” mode with a selected (the) prompt model and LLM model, and a “pair-coder” mode to practice “pair programming” (also known as “extreme programming”) software development process, which utilizes two different pairs of (the) prompt models and LLM Models. In the second setup, the 2 pair models act as pair programmers to automatically create, cross-check, finalize, and verify generated software through the development, testing, and deployment stages, as shown in FIG. 17. The “pair programming” (also known as “extreme programming”) software development process enables AI-driven systematic quality development.

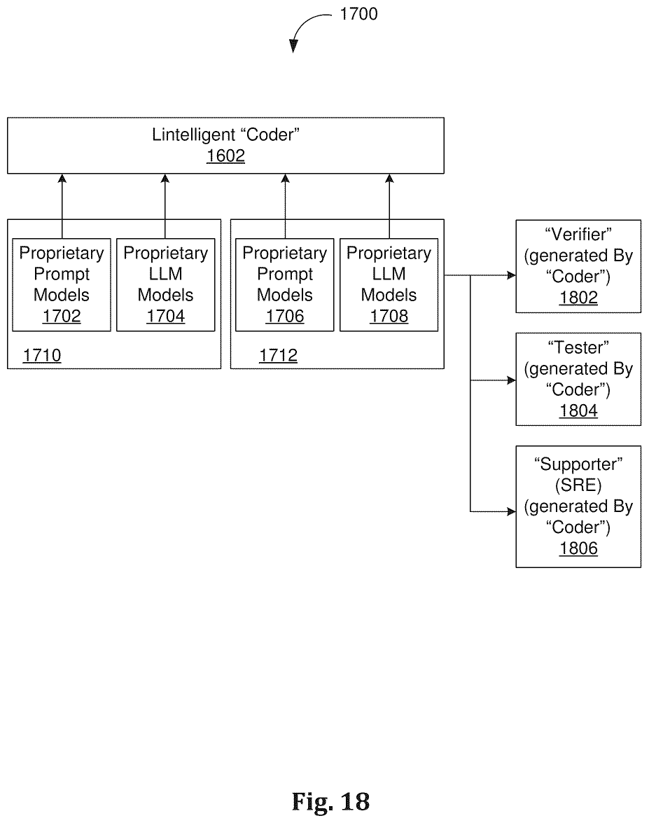

Further, the system produces the end consumer enterprise platform and AI-driven and AI-centric quality assurance systems (as part of the platform) to form a complete suite of Human-less software development toolkits. The quality assurance systems include a pre-code-completion “AI code verifier”, post-code-completion “AI code tester”, and post-production-deployment “AI Site Reliability Engineer (AI SRE)”. These systems are both produced by the platform and operated by AI with no or minimum human coding and operating effort, as shown in FIG. 18.

Further, the system includes built-in support for full-life-cycle development including Packaging end-user software and deploying it to any environment (development, test, or production). After code completion, the system deploys the end product front-to-back with sample data into the testing environment without human intervention.

Further, the system elevates the continuous integration and deployment (CI/CD) process to an autonomous paradigm. Powered by artificial general intelligence, the system self-adapts, learns, and evolves, redefining efficiency and precision in the software development lifecycle.

Further, the system executes end-to-end test cases with relevant workflow from Ul automatically and brings up the Ul to quality control (QC) professionals for final review

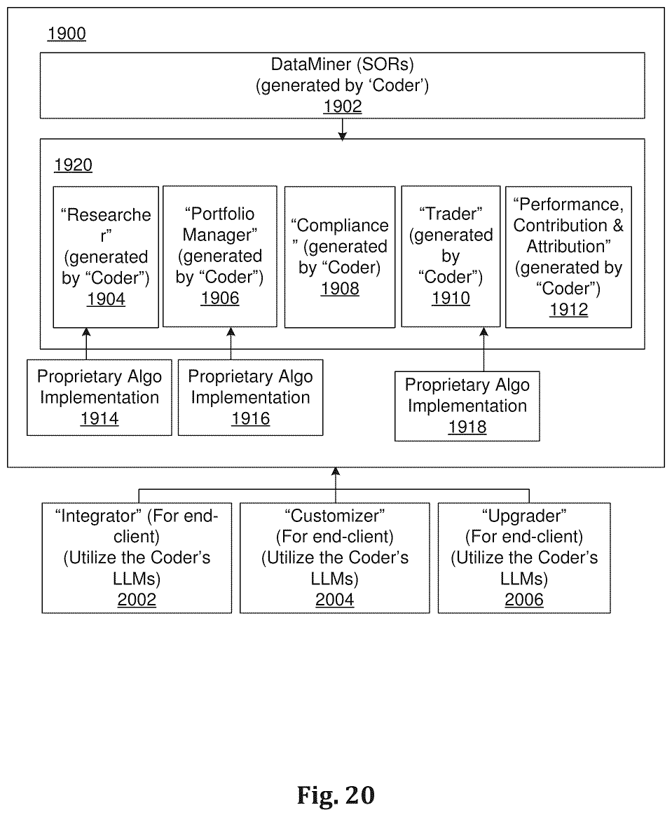

Further, the system is configured for training the proprietary LLMs to “learn” the data and software eco-system of the client, and then generate integration, customization, and upgrading codes with intelligence. The subsystems (of the Platform) that achieve these respectively include the integrator, the customizer, and the upgrader. These 3 subsystems may be built on top of the platform which has full knowledge of the original solution/system that these subsystems built. The knowledge “resides” in the LLM models. Further, by inputting the end client's metadata for its data and service (e.g., Swagger), the system may effectively combine what the system learned in building the original system, with the knowledge of the client's technical ecosystem. Further, the joint knowledge enables the effective creation of the 3 subsystems, as shown in FIG. 20.

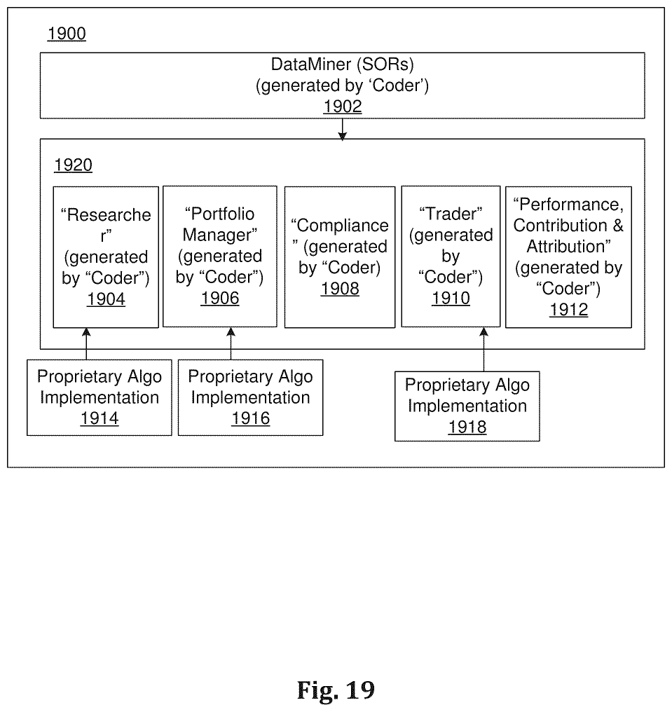

Further, the system may be used to produce a wide spectrum of enterprise systems. The creations of these systems follow coding patterns (in each given domain) with the ability to use dynamic implementation beyond default (the Coder generated) implementation, as shown in FIG. 19. Further, the creation of these systems not only enables AI-driven systematic efficiency (in coding) in general but also unique solutions beyond AI-generated code. The Platform is intended to fundamentally improve the efficiency and quality of the software development industry and can therefore be leveraged by any industry that has important needs for software development. For example, the financial service industry, medical service, pharmaceutical, leisure and travel, manufacturing, education industry, and governmental agencies to name a few.

Further, the present disclosure heralds a groundbreaking shift in the realm of software development. By leveraging the capabilities of Large Language Models and seamlessly integrating state-of-the-art technologies like Docker and Kubernetes, the platform addressed pressing challenges of the modern software development landscape. One of the standout novelties of the platform is the implementation of “pair-programming” carried out entirely by the “human-less coders”. The “pair-programming not only streamlines the development process but also ensures a high degree of code quality and robustness, which is often a challenge in traditional development environments.

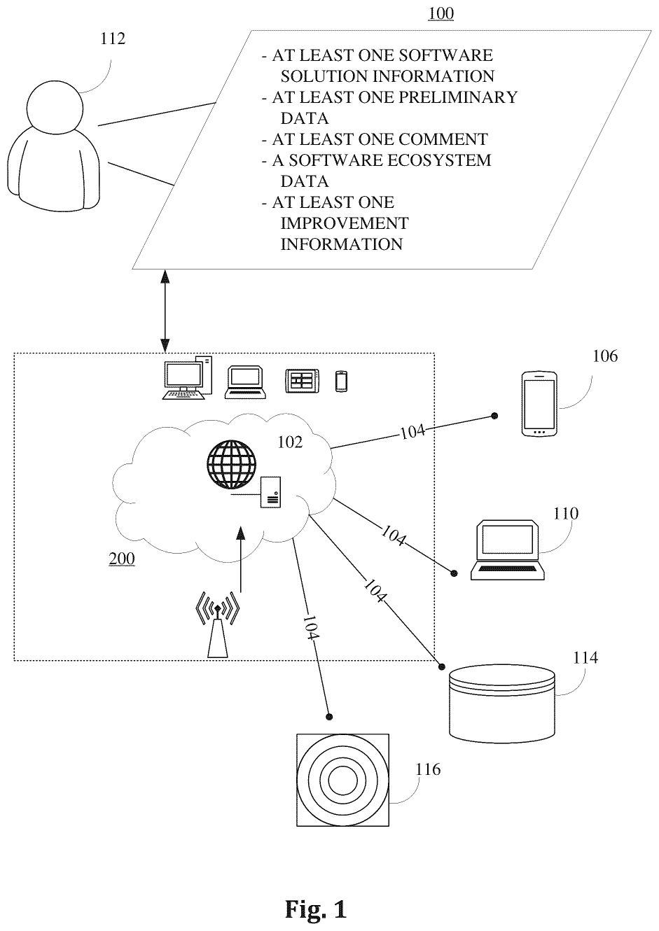

FIG. 1 is an illustration of an online platform 100 consistent with various embodiments of the present disclosure. By way of non-limiting example, the online platform 100 to facilitate provisioning of software solutions may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

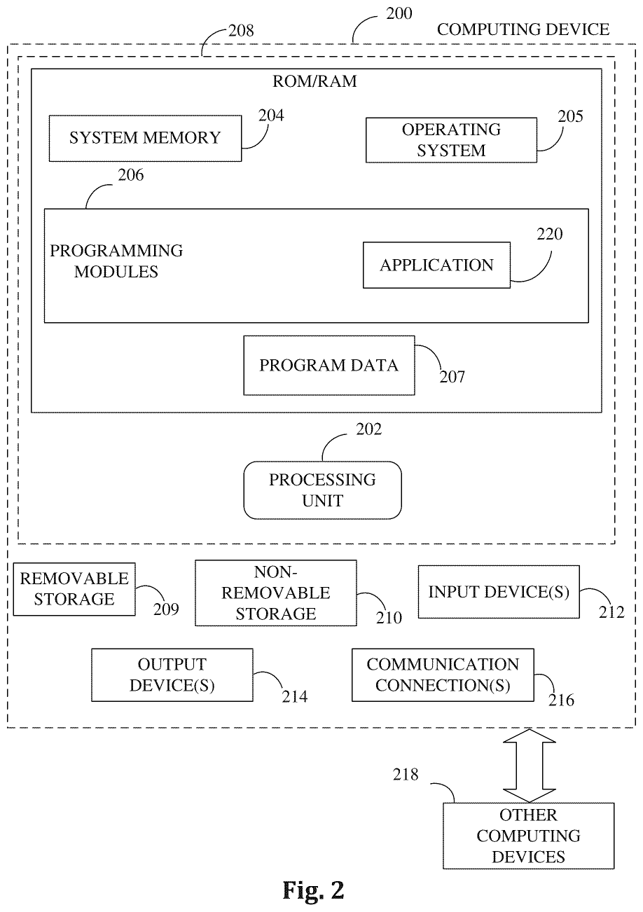

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

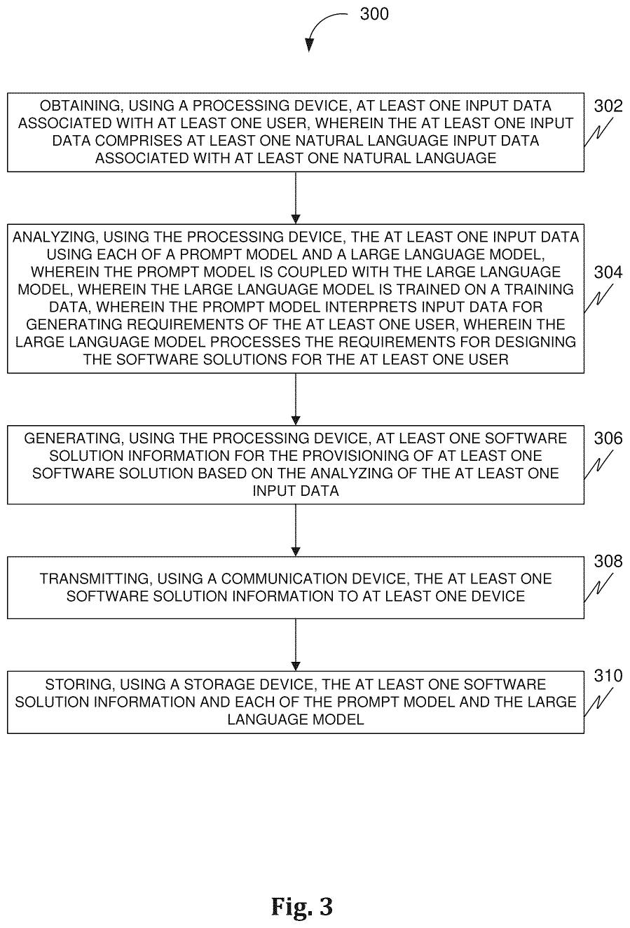

FIG. 3 illustrates a flowchart of a method 300 for facilitating provisioning of software solutions, in accordance with some embodiments.

Accordingly, the method 300 may include a step 302 of obtaining, using a processing device 902, one or more input data associated with one or more users. Further, the one or more input data includes one or more natural language input data associated with one or more natural languages. Further, the method 300 may include a step 304 of analyzing, using the processing device 902, the one or more input data using each of a prompt model and a large language model. Further, the prompt model may be coupled with the large language model. Further, the large language model may be trained on a training data. Further, the prompt model interprets input data for generating requirements of the one or more users. Further, the large language model processes the requirements for designing the software solutions for the one or more users. Further, the method 300 may include a step 306 of generating, using the processing device 902, one or more software solution information for the provisioning of one or more software solutions based on the analyzing of the one or more input data. Further, the method 300 may include a step 308 of transmitting, using a communication device 904, the one or more software solution information to one or more devices 1102. Further, the method 300 may include a step 310 of storing, using a storage device 906, the one or more software solution information and each of the prompt model and the large language model.

In some embodiments, the prompt model may include custom-designed language models specific to the system's functionality. Further, the prompt model may include flexible, rich semantic constructs. Further, the one or more software solution information may include a code, a solution source code, etc. Further, the one or more software solution information may include a programming library. Further, the one or more software solution information may include one or more software application frameworks. Further, the large language model may use transformer models. Further, the one or more natural languages may include one or more languages communicated by the one or more users. Further, the one or more natural languages may include English language. Further, the one or more input data may include a prompt of the one or more users. Further, the at least one input data may include an input provided to a prompt model. Further, the requirements may include system integration touch points. Further, the requirements may include functionalities associated with the software solutions. Further, the at least one device may include a computing device, a client device, etc. Further, the at least one input device may include a client device. Further, the training data may include a data provided to the large language model for training.

Further, in some embodiment, the method 300 may include determining, using the processing device 902, one or more software solution configuration information associated with one or more configurations of the one or more software solutions. Further, the one or more configurations correspond to the requirements of the one or more software solutions. Further, the generating of the one or more software solution information may be based on the one or more software solution configuration information. Further, the one or more software solution information may include a source code for building and deploying the one or more software solutions. Further, the method 300 may include generating, using the processing device 902, the one or more software solutions using the one or more software solution information. Further, the one or more software solutions may be generated based on initiating a build of the one or more software solution information. Further, the method 300 may include provisioning, using the processing device 902, a software solution infrastructure configured to host the one or more software solutions in a software ecosystem of the one or more users. Further, the method 300 may include deploying, using the processing device 902, the one or more software solutions to the software solution infrastructure based on the generating of the one or more software solutions.

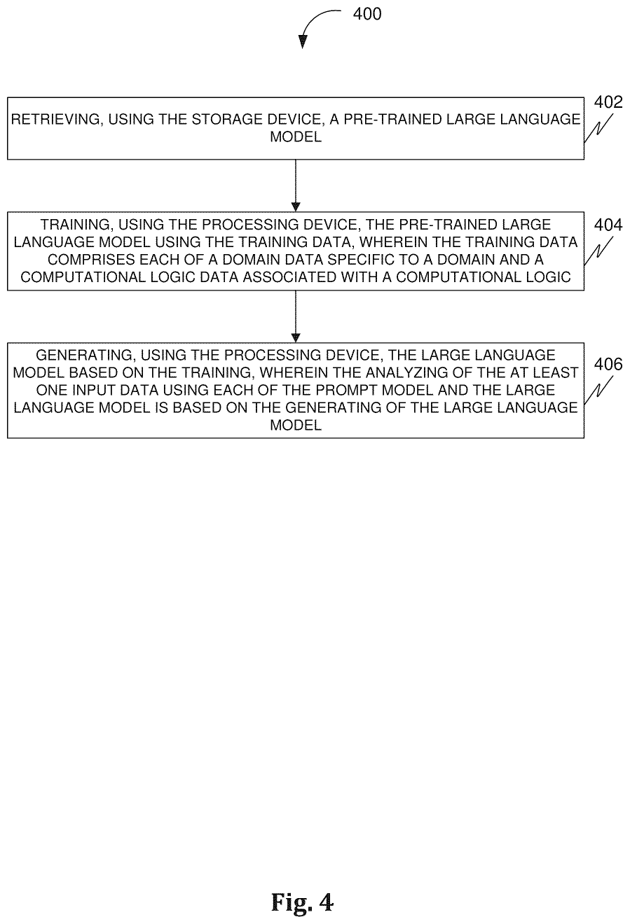

FIG. 4 illustrates a flowchart of a method 400 for facilitating provisioning of software solutions including generating, using the processing device 902, the large language model, in accordance with some embodiments.

Further, in some embodiments, the method 400 may include a step 402 of retrieving, using the storage device 906, a pre-trained large language model. Further, in some embodiments, the method 400 further may include a step 404 of training, using the processing device 902, the pre-trained large language model using the training data. Further, the training data includes each of a domain data specific to a domain and a computational logic data associated with a computational logic. Further, in some embodiments, the method 400 further may include a step 406 of generating, using the processing device 902, the large language model based on the training. Further, the analyzing of the one or more input data using each of the prompt model and the large language model may be based on the generating of the large language model.

In some embodiments, the pre-trained large language model may be trained on a dataset. Further, the computational logic data may include a logic pattern for performing a computation. Further, the computational logic data may include a logic for training the large language model.

In some embodiments, the training of the pre-trained large language model includes embedding one or more information into a model architecture of the pre-trained large language model based on one or more of the domain data and the computational logic data. Further, the training of the pre-trained large language model may include fine tuning the pre-trained language using one or more of the domain data and the computational logic data based on the embedding. Further, the generating of the large language model may be based on the fine tuning of the pre-trained language model.

In some embodiments, the one or more information may include a topical area data associated with the domain data. Further, the topical area data may include one or more of a reference data, a security master, and an investment record. Further, the model architecture may include one or more layers of the large language model.

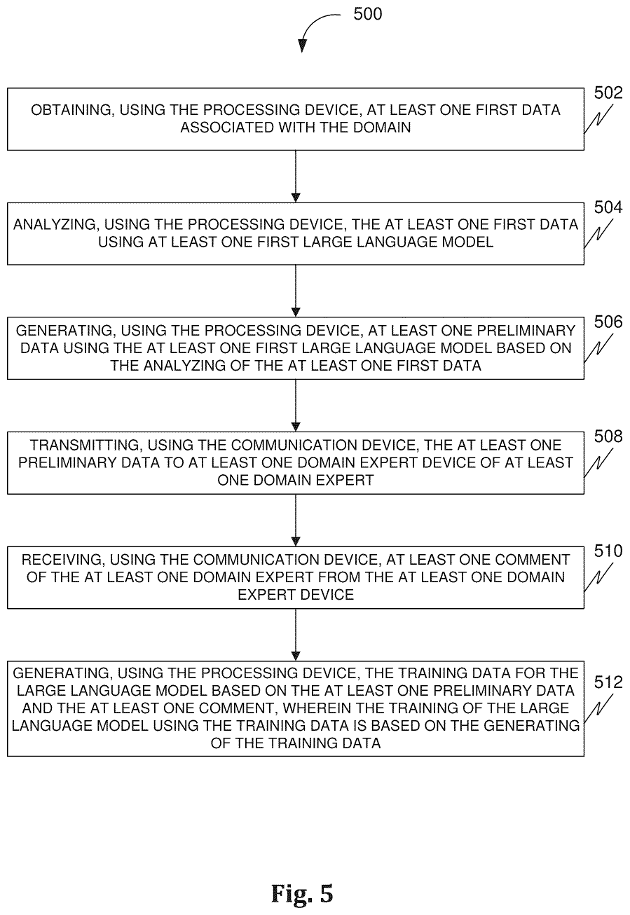

FIG. 5 illustrates a flowchart of a method 500 for facilitating provisioning of software solutions including generating, using the processing device 902, the training data for the large language model, in accordance with some embodiments.

Further, in some embodiments, the large language model may be associated with a domain. Further, the method 500 may include a step 502 of obtaining, using the processing device 902, one or more first data associated with the domain. Further, the method 500 may include a step 504 of analyzing, using the processing device 902, the one or more first data using one or more first large language models. Further, the method 500 may include a step 506 of generating, using the processing device 902, one or more preliminary data using the one or more first large language models based on the analyzing of the one or more first data. Further, the method 500 may include a step 508 of transmitting, using the communication device 904, the one or more preliminary data to one or more domain expert devices 1104 of one or more domain experts. Further, the method 500 may include a step 510 of receiving, using the communication device 904, one or more comments of the one or more domain experts from the one or more domain expert devices 1104. Further, the method 500 may include a step 512 of generating, using the processing device 902, the training data for the large language model based on the one or more preliminary data and the one or more comments. Further, the training of the large language model using the training data may be based on the generating of the training data.

In some embodiments, the one or more first data may be associated with a dataset specific to the standard industry sources. Further, the one or more first large language models may include the MSCI Barra Risk model for risk data and dimensions and the GICs Sector model for sector data and dimensions. Further, the domain may be associated with one or more of an investment banking, a medical, and a technological field. Further, the one or more preliminary data may include an output generated by the MSCI Barra Risk model for risk data and dimensions and the GICs Sector model for sector data and dimensions. Further, the one or more domain expert devices 1104 may be a computing device. Further, the one or more domain experts may include the one or more users. Further, the one or more comments may include a feedback from the one or more users.

In some embodiments, the prompt model includes a first prompt model and a second prompt model. Further, the large language model includes a first language model and a second language model. Further, the first prompt model may be coupled with the first language model. Further, the second prompt model may be coupled with the second language model. Further, the method 300 includes assigning, using the processing device 902, a first role for each of the first prompt model and the first large language model, and a second role for each of the second prompt model and the second large language model. Further, the analyzing of the one or more input data using the each of the prompt model and the large language model includes performing one or more first programming operations by each of the first prompt model and the first large language model based on the first role of each of the first prompt model and the first large language model, and performing one or more second programming operations by each of the second prompt model and the second large language model based on the second role of each of the second prompt model and the second large language model.

In some embodiments, the one or more first programming operations may include generating a code snippet. Further, the first role may include a code creator, a code cross-checker, a code finalizer, a code verifier, etc. Further, the one or more second programming operations may include verifying the one or more first programming operations. Further, the one or more first programming operations and the one or more second programming operations may include code creating, code cross-checking, code finalizing, code verifying, etc.

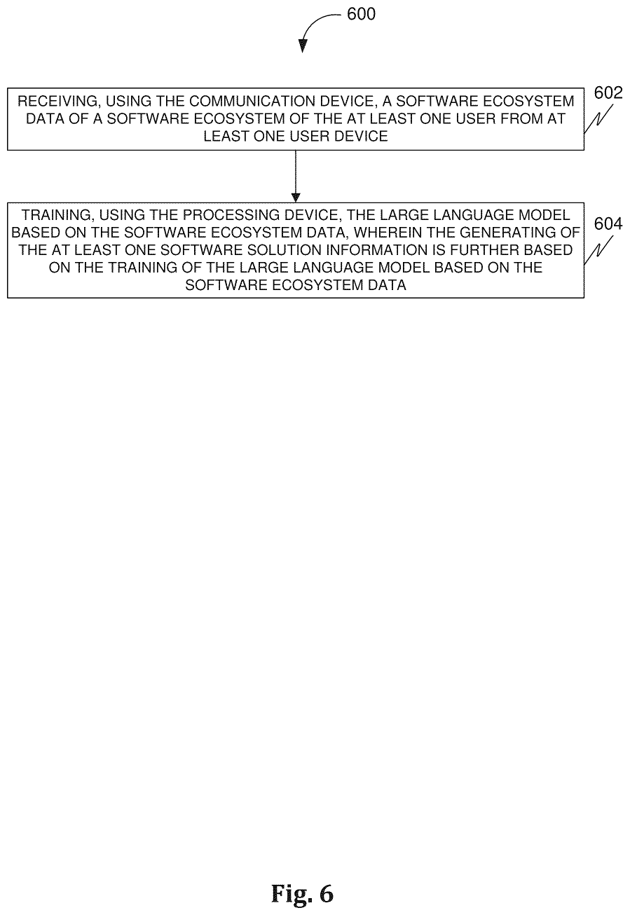

FIG. 6 illustrates a flowchart of a method 600 for facilitating provisioning of software solutions including training, using the processing device 902, the large language model, in accordance with some embodiments.

Further, in some embodiments, the method 600 further may include a step 602 of receiving, using the communication device 904, a software ecosystem data of a software ecosystem of the one or more users from one or more user devices 1106. Further, in some embodiments, the method 600 may include a step 604 of training, using the processing device 902, the large language model based on the software ecosystem data. Further, the generating of the one or more software solution information may be further based on the training of the large language model based on the software ecosystem data.

In some embodiments, the software ecosystem may include hardware, software, etc. associated with the one or more users. Further, the one or more software solutions may be deployed on the software ecosystem. Further, the one or more user devices 1106 may include a computing device. Further, the one or more user devices 1106 may include a PC, laptop, etc.

In some embodiments, the software ecosystem data may be associated with one or more of one or more software systems and one or more software platforms associated with the one or more users. Further, the one or more software solutions includes one or more software subsystems for one or more of the one or more software systems and the one or more software platforms. Further, the one or more software solutions may be for the one or more software subsystems.

In some embodiments, the software platform may include a platform facilitating functioning of a software application. Further, the one or more software subsystems may be built on top of the software platform. Further, the software subsystems may include an Integrator, a Customizer, and an Upgrader. Further, the one or more software solutions may include a range of software packages.

In some embodiments, the one or more software solutions include one or more of one or more software systems, one or more software platforms, and one or more software subsystems for one or more of the one or more software systems and the one or more software platforms. Further, the one or more software solution information may be associated with one or more of the one or more software systems, the one or more software platforms, and the one or more software subsystems.

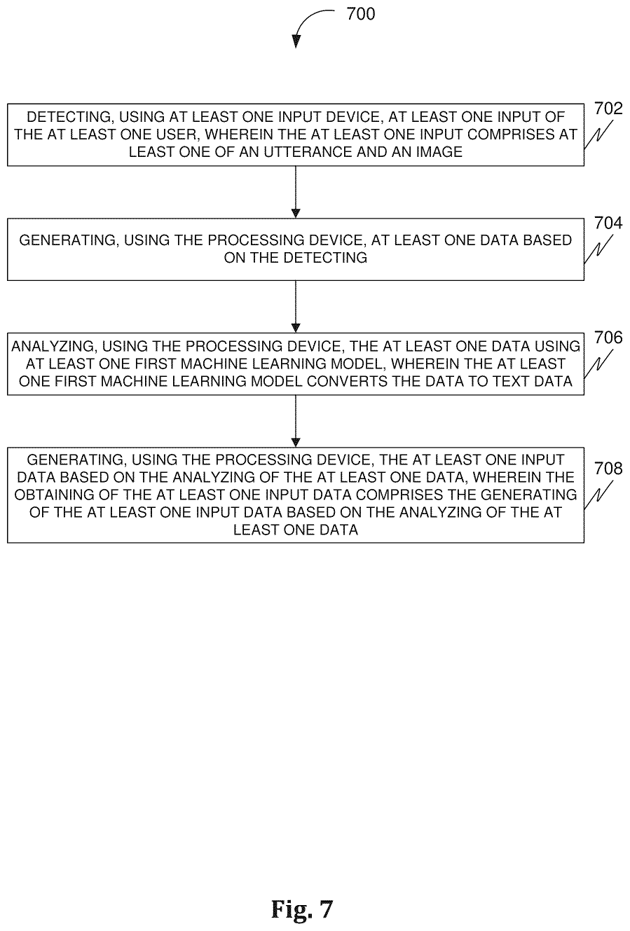

FIG. 7 illustrates a flowchart of a method 700 for facilitating provisioning of software solutions including generating, using the processing device 902, the at least one input data, in accordance with some embodiments.

Further, in some embodiments, the method 700 may include a step 702 of detecting, using one or more input devices 1002, one or more inputs of the one or more users. Further, the one or more inputs include one or more of an utterance and an image. Further, in some embodiments, the method 700 may include a step 704 of generating, using the processing device 902, one or more data based on the detecting. Further, in some embodiments, the method 700 further may include a step 706 of analyzing, using the processing device 902, the one or more data using one or more first machine learning models. Further, the one or more first machine learning models converts the data to text data. Further, in some embodiments, the method 700 further may include a step 708 of generating, using the processing device 902, the one or more input data based on the analyzing of the one or more data. Further, the obtaining of the one or more input data includes the generating of the one or more input data based on the analyzing of the one or more data.

In some embodiments, the one or more input devices 1002 may include a sound sensor, a microphone, etc. Further, the one or more input devices 1002 may include a camera. Further, the one or more input devices 1002 may include a video-capturing device. Further, the converting of the data to the text data may include performing an optical character recogniction and speech recognition.

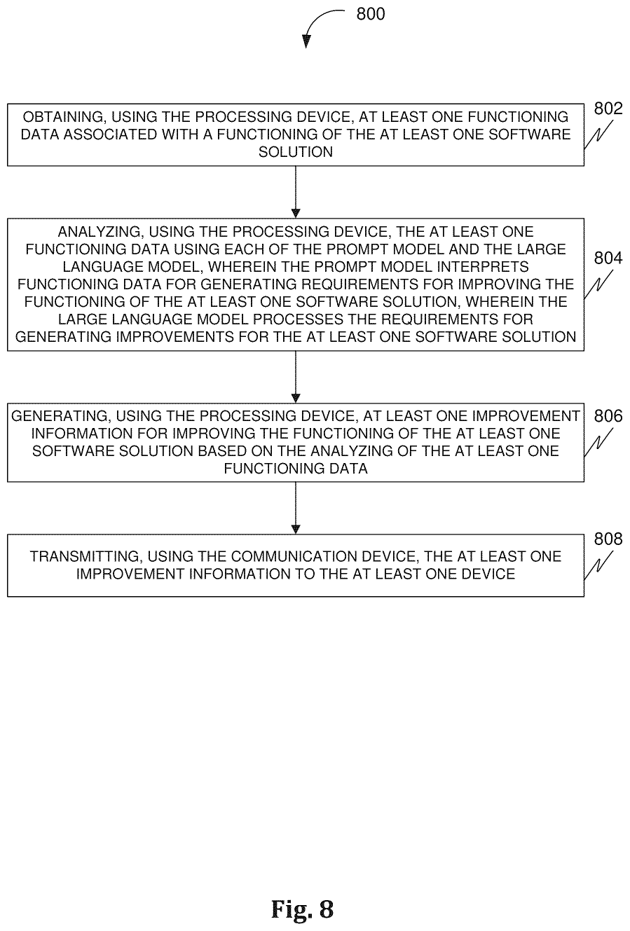

FIG. 8 illustrates a flowchart of a method 800 for facilitating provisioning of software solutions including generating, using the processing device 902, at least one improvement information for improving the functioning of the at least one software solution, in accordance with some embodiments.

Further, in some embodiments, the one or more software solutions may be deployed based on the one or more software solution information. Further, the method 800 further may include a step 802 of obtaining, using the processing device 902, one or more functioning data associated with a functioning of the one or more software solutions. Further, the method 800 further may include a step 804 of analyzing, using the processing device 902, the one or more functioning data using each of the prompt model and the large language model. Further, the prompt model interprets functioning data for generating requirements for improving the functioning of the one or more software solutions. Further, the large language model processes the requirements for generating improvements for the one or more software solutions. Further, the method 800 further may include a step 806 of generating, using the processing device 902, one or more improvement information for improving the functioning of the one or more software solutions based on the analyzing of the one or more functioning data. Further, the method 800 further may include a step 808 of transmitting, using the communication device 904, the one or more improvement information to the one or more devices 1102.

In some embodiments, the one or more functioning data may include a data provided to the large language model after being deployed. Further, the one or more improvement information may be associated with a data required for continuous deployment and continuous integration

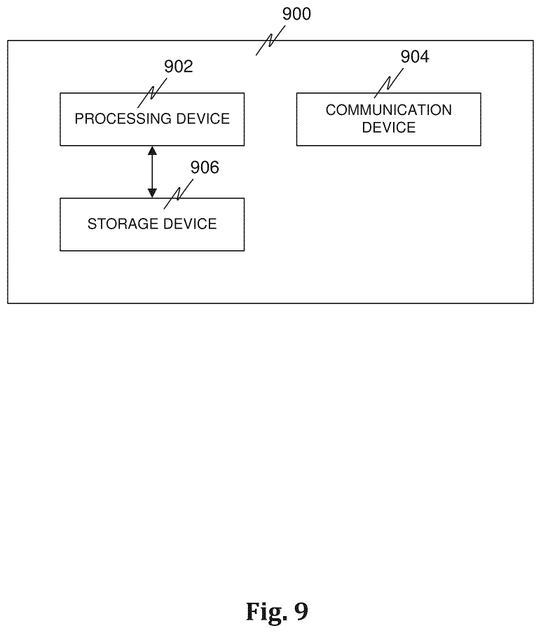

FIG. 9 illustrates a block diagram of a system 900 for facilitating provisioning of software solutions, in accordance with some embodiments.

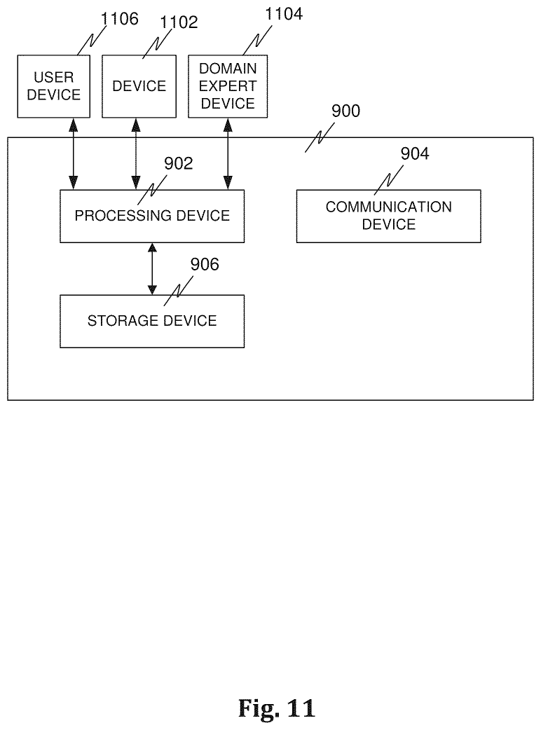

Accordingly, the system 900 may include a processing device 902. Further, the processing device 902 may be configured for obtaining one or more input data associated with one or more users. Further, the one or more input data includes one or more natural language input data associated with one or more natural languages. Further, the processing device 902 may be configured for analyzing the one or more input data using each of a prompt model and a large language model. Further, the prompt model may be coupled with the large language model. Further, the large language model may be trained on a training data. Further, the prompt model interprets input data for generating requirements of the one or more users. Further, the large language model processes the requirements for designing the software solutions for the one or more users. Further, the processing device 902 may be configured for generating one or more software solution information for the provisioning of one or more software solutions based on the analyzing of the one or more input data. Further, the system 900 may include a communication device 904 which may be configured for transmitting the one or more software solution information to one or more devices 1102, as shown in FIG. 11. Further, the system 900 may include a storage device 906 which may be configured for storing the one or more software solution information and each of the prompt model and the large language model.

In some embodiments, the storage device 906 may be configured for retrieving, a pre-trained large language model. Further, the processing device 902 may be configured for training the pre-trained large language model using the training data. Further, the training data includes each of a domain data specific to a domain and a computational logic data associated with a computational logic. Further, the processing device 902 may be configured for generating the large language model based on the training. Further, the analyzing of the one or more input data using each of the prompt model and the large language model may be based on the generating of the large language model.

In some embodiments, the training of the pre-trained large language model includes embedding one or more information into a model architecture of the pre-trained large language model based on one or more of the domain data and the computational logic data. Further, the training of the pre-trained large language model may include fine-tuning the pre-trained language using one or more of the domain data and the computational logic data based on the embedding. Further, the generating of the large language model may be further based on the fine tuning of the pre-trained language model.

Further, in some embodiments, the large language model may be associated with a domain. Further, the processing device 902 may be further configured for obtaining one or more first data associated with the domain. Further, the processing device 902 may be further configured for analyzing the one or more first data using one or more first large language models. Further, the processing device 902 may be further configured for generating one or more preliminary data using the one or more first large language models based on the analyzing of the one or more first data. Further, the processing device 902 may be further configured for generating the training data for the large language model based on the one or more preliminary data and one or more comments. Further, the training of the large language model using the training data may be based on the generating of the training data. Further, the communication device 904 may be further configured for transmitting the one or more preliminary data to one or more domain expert devices 1104, as shown in FIG. 11, of one or more domain experts. Further, the communication device 904 may be further configured for receiving the one or more comments of the one or more domain experts from the one or more domain expert devices 1104.

In some embodiments, the prompt model includes a first prompt model and a second prompt model. Further, the large language model includes a first language model and a second language model. Further, the first prompt model may be coupled with the first language model. Further, the second prompt model may be coupled with the second language model. Further, the processing device 902 may be configured for assigning a first role for each of the first prompt model and the first large language model, and a second role for each of the second prompt model and the second large language model. Further, the analyzing of the one or more input data using the each of the prompt model and the large language model includes performing one or more first programming operations by each of the first prompt model and the first large language model based on the first role of each of the first prompt model and the first large language model, and performing one or more second programming operations by each of the second prompt model and the second large language model based on the second role of each of the second prompt model and the second large language model.

In some embodiments, the communication device 904 may be further configured for receiving software ecosystem data of a software ecosystem of the one or more users from one or more user devices 1106, as shown in FIG. 11. Further, the processing device 902 may be further configured for training the large language model based on the software ecosystem data. Further, the generating of the one or more software solution information may be based on the training of the large language model based on the software ecosystem data.

In some embodiments, the software ecosystem data may be associated with one or more of one or more software systems and one or more software platforms associated with the one or more users. Further, the one or more software solutions include one or more software subsystems for one or more of the one or more software systems and the one or more software platforms. Further, the one or more software solutions may be for the one or more software subsystems.

In some embodiments, the one or more software solutions include one or more of one or more software systems, one or more software platforms, and one or more software subsystems for one or more of the one or more software systems and the one or more software platforms. Further, the one or more software solution information may be associated with one or more of the one or more software systems, the one or more software platforms, and the one or more software subsystems.

Further, in some embodiments, the system 900 may include one or more input devices 1002 communicatively coupled with the processing device 904. Further, the one or more input devices 1002 may be configured for detecting one or more inputs of the one or more users. Further, the one or more inputs may include one or more of an utterance and an image, may. Further, the processing device 902 may be configured for generating one or more data based on the detecting. Further, the one or more input devices 1002 may be configured for detecting one or more inputs of the one or more users. Further, the processing device 902 may be configured for analyzing the one or more data using one or more first machine learning models. Further, the one or more first machine learning models converts the data to text data. Further, the one or more input devices 1002 may be configured for detecting one or more inputs of the one or more users. Further, the processing device 902 may be configured for generating the one or more input data based on the analyzing of the one or more data. Further, the obtaining of the one or more input data includes the generating of the one or more input data based on the analyzing of the one or more data.

Further, in some embodiments, the one or more software solutions may be deployed based on the one or more software solution information. Further, the processing device 902 may be configured for obtaining one or more functioning data associated with a functioning of the one or more software solutions. Further, the processing device 902 may be configured for analyzing the one or more functioning data using each of the prompt model and the large language model. Further, the prompt model interprets functioning data for generating requirements for improving the functioning of the one or more software solutions. Further, the large language model processes the requirements for generating improvements for the one or more software solutions. Further, the processing device 902 may be configured for generating one or more improvement information for improving the functioning of the one or more software solutions based on the analyzing of the one or more functioning data. Further, the communication device 904 may be further configured for transmitting the one or more improvement information to the one or more devices 1102.

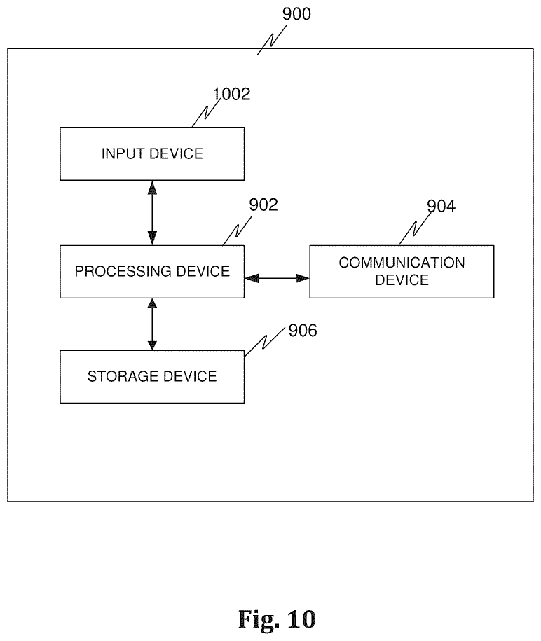

FIG. 10 illustrates a block diagram of the system 900 comprising the one or more input devices 1002 for facilitating the provisioning of the software solutions, in accordance with some embodiments.

FIG. 11 illustrates a block diagram of the system 900, in accordance with some embodiments.

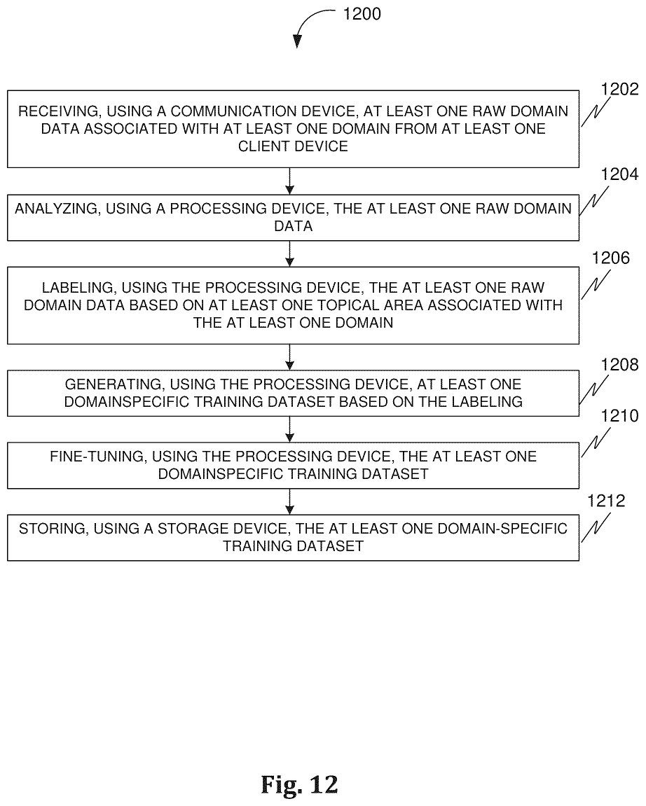

FIG. 12 is a flowchart of a method 1200 for facilitating software development using artificial intelligence models, in accordance with some embodiments.

Further, the method 1200 may include a step 1202 of receiving, using a communication device, at least one raw domain data associated with at least one domain from at least one client device. Further, for example, the at least one domain may include financial service industries, medical services, pharmaceuticals, leisure and travel, manufacturing, education industry, and governmental agencies.

Further, the method 1200 may include a step 1204 of analyzing, using a processing device, the at least one raw domain data.

Further, the method 1200 may include a step 1206 of labeling, using the processing device, the at least one raw domain data based on at least one topical area associated with the at least one domain. Further, for example, the at least one topical area may include investment management security master, investment book of record, market data, reference data, etc.

Further, the method 1200 may include a step of generating 1208, using the processing device, at least one domain-specific training dataset based on the labeling. Further, the at least one domain-specific training dataset may be utilized for training at least one artificial intelligence model configured for facilitating software development in the at least one domain.

Further, the method 1200 may include a step 1210 of fine-tuning, using the processing device, the at least one domain-specific training dataset.

Further, the method 1200 may include a step 1212 of storing, using a storage device, the at least one domain-specific training dataset.

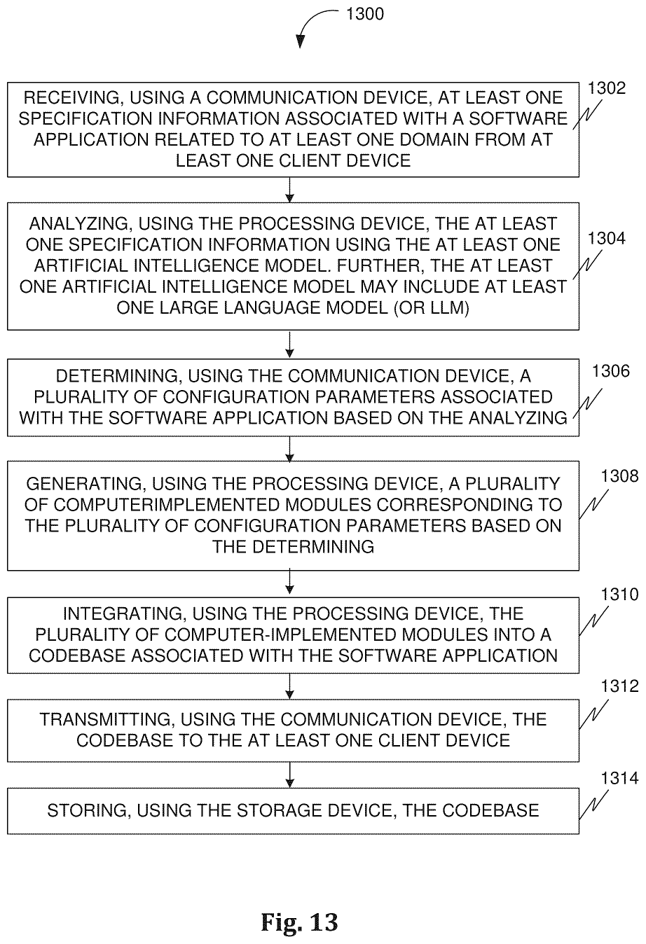

FIG. 13 is a flowchart of a method 1300 for facilitating software development using artificial intelligence models, in accordance with some embodiments.

Further, the method 1300 may include a step 1302 of receiving, using a communication device, at least one specification information associated with a software application related to at least one domain from at least one client device. Further, for example, the at least one domain may include financial service industries, medical services, pharmaceuticals, leisure and travel, manufacturing, education industry, and governmental agencies. Further, the at least one client device may include a desktop, a laptop, a tablet computer, etc.

Further, the method 1300 may include a step 1304 of analyzing, using the processing device, the at least one specification information using the at least one artificial intelligence model. Further, the at least one artificial intelligence model may include at least one large language model (or LLM).

Further, the method 1300 may include a step 1306 of determining, using the communication device, a plurality of configuration parameters associated with the software application based on the analyzing.

Further, the method 1300 may include a step 1308 of generating, using the processing device, a plurality of computer-implemented modules corresponding to the plurality of configuration parameters based on the determining. Further, at least one computer-implemented module of the plurality of computer-implemented modules may include a plurality of code snippets associated with at least one of a programming language, a software application framework, a programming library, etc.

Further, the method 1300 may include a step 1310 of integrating, using the processing device, the plurality of computer-implemented modules into a codebase associated with the software application.

Further, the method 1300 may include a step 1312 of transmitting, using the communication device, the codebase to the at least one client device.

Further, the method 1300 may include a step 1314 of storing, using the storage device, the codebase.

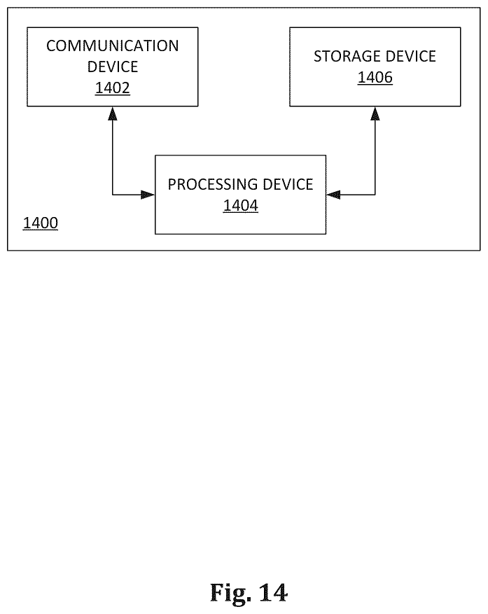

FIG. 14 is a block diagram of a system 1400 for facilitating software development using artificial intelligence models, in accordance with some embodiments. Accordingly, the system 1400 may include a communication device 1402, a processing device 1404, and a storage device 1406. Further, the storage device 1406 may be communicatively coupled with the processing device 1404. Further, the storage device 1406 may be communicatively coupled with the communication device 1402. Further, the communication device 1402 may be communicatively coupled with the processing device 1404.

Further, the communication device 1402 may be configured for receiving at least one specification information associated with a software application related to at least one domain from at least one client device. Further, for example, the at least one domain may include financial service industries, medical services, pharmaceuticals, leisure and travel, manufacturing, education industry, and governmental agencies. Further, the at least one client device may include a desktop, a laptop, a tablet computer, etc. Further, the communication device 1402 may be configured for transmitting a codebase to the at least one client device.

Further, the processing device 1404 may be configured for analyzing the at least one specification information using the at least one artificial intelligence model. Further, the at least one artificial intelligence model may include at least one large language model (or LLM). Further, the processing device 1404 may be configured for determining a plurality of configuration parameters associated with the software application based on the analyzing. Further, the processing device 1404 may be configured for generating a plurality of computer-implemented modules corresponding to the plurality of configuration parameters based on the determining. Further, at least one computer-implemented module of the plurality of computer-implemented modules may include a plurality of code snippets associated with at least one of a programming language, a software application framework, a programming library, etc. Further, the processing device 1404 may be configured for integrating the plurality of computer-implemented modules into the codebase associated with the software application.

Further, the storage device 1406 may be configured for storing the codebase.

FIG. 15 is a block diagram of a system 1500 for facilitating software development using artificial intelligence models, in accordance with some embodiments. Further, the system may include an Lintelligent “AI Coder” Solution Suite 1502, an Asset Management Solution Suite 1504, a Medical Service Solution 1506, and a pharmaceutical industry solution suite 1508. Further, the Lintelligent “AI Coder” Solution Suite 1502 may be connected with the Asset Management Solution Suite 1504. Further, the Lintelligent “AI Coder” Solution Suite 1502 may be connected with the Medical Service Solution 1506. Further, the Lintelligent “AI Coder” 1502 may be connected with the pharmaceutical industry solution suite 1508. Accordingly, the system 1500 may be associated with an artificial intelligence (AI) based software development platform configured to produce a plurality of enterprise software platforms of end-to-end capabilities from a user interface to server-side logic to data storage and usage, serving global locations concurrently with scale, and minimum human coding effort. Further, the plurality of enterprise software platforms may be associated with a broad spectrum of computational languages that may include, but may not be limited to, React JS, Java, Python, Rust, etc.

FIG. 16 is a block diagram of a system 1600 for facilitating software development using artificial intelligence models, in accordance with some embodiments. Further, the system 1600 may include Lintelligent “Coder” 1602, proprietary prompt models 1604, and proprietary LLM models 1606. Further, the Lintelligent “Coder” may be connected with the proprietary prompt models 1604 and proprietary LLM models 1606. Accordingly, the system 1600 may be configured for training and fine-tuning a plurality of LLM models. Further, the training and fine-tuning may include a process of building out extensive training data on “domain data” for relevant topical areas of a specific domain. Further, the system 1600 may operate in a single-coder mode.

FIG. 17 is a block diagram of a system 1700 for facilitating software development using artificial intelligence models, in accordance with some embodiments. Further, the system 1700 may include a first coder 1710 and a second coder 1712. Further, the first coder 1710 may include proprietary prompt models 1702 and proprietary LLM models 1704. Further, the second coder 1712 may include proprietary prompt models 1706 and proprietary LLM models 1708. Further, the proprietary prompt models 1702 and proprietary LLM models 1704 of the first coder 1710 may be connected with the Lintelligent “Coder” 1602. Further, the proprietary prompt models 1706 and proprietary LLM models 1708 of the second coder 1712 may be connected with the Lintelligent “Coder” 1602. Further, the system 1700 may operate in a “pair-coder” mode to practice “pair programming” (also known as “extreme programming”) software development process, that utilizes two different pairs of the prompt models and LLM models.

FIG. 18 is a block diagram of the system 1700 for facilitating software development using artificial intelligence models, in accordance with some embodiments. Further, the system may include a “Verifier” 1802, a “Tester” 1804, and a “Supporter” (SRE) 1806. Further, the “Verifier” 1802, the “Tester” 1804, and the “Supporter” (SRE) 1806 may be generated by the Lintelligent “Coder” 1602. Further, the “Verifier” 1802, the “Tester” 1804, and the “Supporter” (SRE) 1806 may be associated with at least one of the first coder 1710 and the second coder 1712. Further, the system 1700 may be configured for producing a plurality of end consumer enterprise platforms and AI-driven and AI-centric quality assurance systems (such as the “Verifier” 1802, the “Tester” 1804 and the “Supporter” (SRE) 1806) to form a complete suite of human-less software development toolkits.

FIG. 19 is a block diagram of a system 1900 for facilitating software development using artificial intelligence models, in accordance with some embodiments. Further, the system 1900 may include a DataMiner (SORs) 1902 and an enterprise system 1920. Further, the DataMiner (SORs) 1902 may be connected with the enterprise system 1920. Further, the enterprise system may include a “Researcher” 1904, a “Portfolio Manager” 1906, a “Compliance” 1908, a “Trader” 1910, and a “Performance Contribution & attribution” 1912. Further, the DataMiner (SORs) 1902, the “Researcher” 1904, the “Portfolio Manager” 1906, the “Compliance” 1908, the “Trader” 1910, and the “Performance Contribution & attribution” 1912 may be generated by a Lintelligent “Coder” (such as the Lintelligent “Coder 1602). Further, the “Researcher” 1904 may be associated with a proprietary Algo implementation 1914. Further, the “Portfolio Manager” 1906 may be associated with a proprietary Algo implementation 1916. Further, the “Trader” 1910 may be associated with a proprietary Algo implementation 1918. Further, the system 1900 may be used to produce a wide spectrum of enterprise systems 1920 by following a plurality of coding patterns with an ability to use dynamic implementation beyond default.

FIG. 20 is a block diagram of the system 1900 for facilitating the software development using the artificial intelligence models, in accordance with some embodiments. Further, the system may be associated with an “Integrator” 2002, a “Customizer” 2004 and an “Upgrader” 2006. Further, the “Integrator” 2002, the “Customizer” 2004 and the “Upgrader” 2006 may be for end client. Further, the “Integrator” 2002, the “Customizer” 2004 and the “Upgrader” 2006 may utilize a Lintelligent “Coder” (such as the Lintelligent “Coder” 1602).

Although the invention has been explained in relation to its preferred embodiment, it is to be understood that many other possible modifications and variations can be made without departing from the spirit and scope of the invention as hereinafter claimed.

What is claimed is:

1. A method for facilitating provisioning of software solutions, the method comprising:
obtaining, using a processing device, at least one input data associated with at least one user, wherein the at least one input data comprises at least one natural language input data associated with at least one natural language;
analyzing, using the processing device, the at least one input data using each of a prompt model and a large language model, wherein the prompt model is coupled with the large language model, wherein the large language model is trained on a training data, wherein the prompt model interprets input data for generating requirements of the at least one user, wherein the large language model processes the requirements for designing the software solutions for the at least one user;
generating, using the processing device, at least one software solution information for the provisioning of at least one software solution based on the analyzing of the at least one input data;
transmitting, using a communication device, the at least one software solution information to at least one device; and
storing, using a storage device, the at least one software solution information and each of the prompt model and the large language model.

2. The method of claim 1 further comprising:
retrieving, using the storage device, a pre-trained large language model;
training, using the processing device, the pre-trained large language model using the training data, wherein the training data comprises each of a domain data specific to a domain and a computational logic data associated with a computational logic; and
generating, using the processing device, the large language model based on the training, wherein the analyzing of the at least one input data using each of the prompt model and the large language model is based on the generating of the large language model.

3. The method of claim 2, wherein the training of the pre-trained large language model comprises embedding at least one information into a model architecture of the pre-trained large language model based on at least one of the domain data and the computational logic data, wherein the training of the pre-trained large language model further comprising fine tuning the pre-trained language using at least one of the domain data and the computational logic data based on the embedding, wherein the generating of the large language model is further based on the fine tuning of the pre-trained language model.

4. The method of claim 2, wherein the large language model is associated with a domain, wherein the method further comprises:
obtaining, using the processing device, at least one first data associated with the domain;
analyzing, using the processing device, the at least one first data using at least one first large language model;
generating, using the processing device, at least one preliminary data using the at least one first large language model based on the analyzing of the at least one first data;
transmitting, using the communication device, the at least one preliminary data to at least one domain expert device of at least one domain expert;
receiving, using the communication device, at least one comment of the at least one domain expert from the at least one domain expert device; and
generating, using the processing device, the training data for the large language model based on the at least one preliminary data and the at least one comment, wherein the training of the large language model using the training data is based on the generating of the training data.

5. The method of claim 1, wherein the prompt model comprises a first prompt model and a second prompt model, wherein the large language model comprises a first language model and a second language model, wherein the first prompt model is coupled with the first language model, wherein the second prompt model is coupled with the second language model, wherein the method comprises assigning, using the processing device, a first role for each of the first prompt model and the first large language model, and a second role for each of the second prompt model and the second large language model, wherein the analyzing of the at least one input data using the each of the prompt model and the large language model comprises performing at least one first programming operation by each of the first prompt model and the first large language model based on the first role of each of the first prompt model and the first large language model, and performing at least one second programming operation by each of the second prompt model and the second large language model based on the second role of each of the second prompt model and the second large language model.

6. The method of claim 1 further comprising:
receiving, using the communication device, a software ecosystem data of a software ecosystem of the at least one user from at least one user device; and
training, using the processing device, the large language model based on the software ecosystem data, wherein the generating of the at least one software solution information is further based on the training of the large language model based on the software ecosystem data.

7. The method of claim 6, wherein the software ecosystem data is associated with at least one of at least one software system and at least one software platform associated with the at least one user, wherein the at least one software solution comprises at least one software subsystem for at least one of the at least one software system and the at least one software platform, wherein the at least one software solution is for the at least one software subsystem.

8. The method of claim 1, wherein the at least one software solution comprises at least one of at least one software system, at least one software platform, and at least one software subsystem for at least one of the at least one software system and the at least one software platform, wherein the at least one software solution information is associated with at least one of the at least one software system, the at least one software platform, and the at least one software subsystem.

9. The method of claim 1 further comprising:
detecting, using at least one input device, at least one input of the at least one user, wherein the at least one input comprises at least one of an utterance and an image;
generating, using the processing device, at least one data based on the detecting;
analyzing, using the processing device, the at least one data using at least one first machine learning model, wherein the at least one first machine learning model converts the data to text data; and
generating, using the processing device, the at least one input data based on the analyzing of the at least one data, wherein the obtaining of the at least one input data comprises the generating of the at least one input data based on the analyzing of the at least one data.

10. The method of claim 1, wherein the at least one software solution is deployed based on the at least one software solution information, wherein the method further comprising:
obtaining, using the processing device, at least one functioning data associated with a functioning of the at least one software solution;
analyzing, using the processing device, the at least one functioning data using each of the prompt model and the large language model, wherein the prompt model interprets functioning data for generating requirements for improving the functioning of the at least one software solution, wherein the large language model processes the requirements for generating improvements for the at least one software solution;
generating, using the processing device, at least one improvement information for improving the functioning of the at least one software solution based on the analyzing of the at least one functioning data; and
transmitting, using the communication device, the at least one improvement information to the at least one device.

11. A system for facilitating provisioning of software solutions, the system comprising:
a processing device configured for:
obtaining at least one input data associated with at least one user, wherein the at least one input data comprises at least one natural language input data associated with at least one natural language;
analyzing the at least one input data using each of a prompt model and a large language model, wherein the prompt model is coupled with the large language model, wherein the large language model is trained on a training data, wherein the prompt model interprets input data for generating requirements of the at least one user, wherein the large language model processes the requirements for designing the software solutions for the at least one user; and
generating at least one software solution information for the provisioning of at least one software solution based on the analyzing of the at least one input data;
a communication device communicatively coupled with the processing device, wherein the communication device is configured for transmitting the at least one software solution information to at least one device; and
a storage device communicatively coupled with the processing device, wherein the storage device is configured for storing the at least one software solution information and each of the prompt model and the large language model.

12. The system of claim 11, wherein the storage device is further configured for retrieving a pre-trained large language model, wherein the processing device is further configured for
training the pre-trained large language model using the training data, wherein the training data comprises each of a domain data specific to a domain and a computational logic data associated with a computational logic; and
generating the large language model based on the training, wherein the analyzing of the at least one input data using each of the prompt model and the large language model is based on the generating of the large language model.

13. The system of claim 12, wherein the training of the pre-trained large language model comprises embedding at least one information into a model architecture of the pre-trained large language model based on at least one of the domain data and the computational logic data, wherein the training of the pre-trained large language model further comprises fine tuning the pre-trained language using at least one of the domain data and the computational logic data based on the embedding, wherein the generating of the large language model is further based on the fine tuning of the pre-trained language model.

14. The system of claim 12, wherein the large language model is associated with a domain, wherein the processing device is further configured for:
obtaining at least one first data associated with the domain;
analyzing the at least one first data using at least one first large language model;
generating at least one preliminary data using the at least one first large language model based on the analyzing of the at least one first data; and
generating the training data for the large language model based on the at least one preliminary data and at least one comment, wherein the training of the large language model using the training data is based on the generating of the training data, wherein the communication device is further configured for:
transmitting the at least one preliminary data to at least one domain expert device of at least one domain expert; and
receiving the at least one comment of the at least one domain expert from the at least one domain expert device.

15. The system of claim 11, wherein the prompt model comprises a first prompt model and a second prompt model, wherein the large language model comprises a first language model and a second language model, wherein the first prompt model is coupled with the first language model, wherein the second prompt model is coupled with the second language model, wherein the processing device is further configured for assigning a first role for each of the first prompt model and the first large language model, and a second role for each of the second prompt model and the second large language model, wherein the analyzing of the at least one input data using the each of the prompt model and the large language model comprises performing at least one first programming operation by each of the first prompt model and the first large language model based on the first role of each of the first prompt model and the first large language model, and performing at least one second programming operation by each of the second prompt model and the second large language model based on the second role of each of the second prompt model and the second large language model.

16. The system of claim 11, wherein the communication device is further configured for receiving a software ecosystem data of a software ecosystem of the at least one user from at least one user device, wherein the processing device is further configured for training the large language model based on the software ecosystem data, wherein the generating of the at least one software solution information is further based on the training of the large language model based on the software ecosystem data.

17. The system of claim 16, wherein the software ecosystem data is associated with at least one of at least one software system and at least one software platform associated with the at least one user, wherein the at least one software solution comprises at least one software subsystem for at least one of the at least one software system and the at least one software platform, wherein the at least one software solution is for the at least one software subsystem.

18. The system of claim 11, wherein the at least one software solution comprises at least one of at least one software system, at least one software platform, and at least one software subsystem for at least one of the at least one software system and the at least one software platform, wherein the at least one software solution information is associated with at least one of the at least one software system, the at least one software platform, and the at least one software subsystem.

19. The system of claim 11 further comprising at least one input device communicatively coupled with the processing device, wherein the at least one input device is configured for detecting at least one input of the at least one user, wherein the at least one input comprises at least one of an utterance and an image, wherein the processing device is further configured for:
generating at least one data based on the detecting;
analyzing the at least one data using at least one first machine learning model, wherein the at least one first machine learning model converts the data to text data; and
generating the at least one input data based on the analyzing of the at least one data, wherein the obtaining of the at least one input data comprises the generating of the at least one input data based on the analyzing of the at least one data.

20. The system of claim 11, wherein the at least one software solution is deployed based on the at least one software solution information, wherein the processing device is further configured for:
obtaining at least one functioning data associated with a functioning of the at least one software solution;
analyzing the at least one functioning data using each of the prompt model and the large language model, wherein the prompt model interprets functioning data for generating requirements for improving the functioning of the at least one software solution, wherein the large language model processes the requirements for generating improvements for the at least one software solution; and
generating at least one improvement information for improving the functioning of the at least one software solution based on the analyzing of the at least one functioning data, wherein the communication device is further configured for transmitting the at least one improvement information to the at least one device.
